(19) United States
(12) Patent Application Publication
(10) Pub. No.: US 2023/0337673 A1
(43) Pub. Date: Oct. 26, 2023

(54) HERBICIDAL COMPOSITION BASED ON TOPRAMEZONE OR SALT ACTIVE SUBSTANCE THEREOF

(71) Applicant: Rotam Agrochem International Company Limited, Chai Wan (HK)

(72) Inventor: James Timothy Bristow, Chai Wan (HK)

(21) Appl. No.: 17/726,751

(22) Filed: Apr. 22, 2022

(51) Int. Cl. A01N 43/80; A01N 37/46; A01N 57/20; A01N 25/04

(52) U.S. Cl. CPC A01N 43/80; A01N 37/46; A01N 57/20; A01N 25/04

(57) ABSTRACT

A herbicidal composition comprising at least one amino carboxylate and/or organic phosphonate and topramezone or a salt active substance thereof is provided. An aqueous spray solution, which comprises topramezone or a salt active substance thereof, amino carboxylate and/or organic phosphonate and water is also provided. The use of the amino carboxylate and/or organic phosphonate in inhibiting the flocculation of the topramezone or a salt active substance thereof when spraying the aqueous spray solution comprising at least one amino carboxylate and/or organic phosphonate and topramezone or a salt active substance thereof is also provided.

### TECHNICAL FIELD

The present invention relates to a herbicidal composition based on topramezone or a salt active substance thereof, in particular to a new use of amino carboxylate and/or organic phosphonate for preventing the flocculation in the application process of an aqueous spray solution based on topramezone or a salt thereof.

### BACKGROUND ART

Topramezone (English common name) with a chemical name [3-(4,5-dihydro-3-isoxazolyl)-4-methylsulfonyl-2-methylbenzene]5-hydroxy-1-methyl-1H-pyrazol-4-yl)methanone is the first pyrazolone benzoate herbicide developed by BASF and is a new type of pyrazolone-based intake transportation herbicide for post-emergence stem and leaf treatment. Topramezone and the preparation thereof are known from WO 98/31681 and WO 99/58509.

Topramezone can effectively kill annual gramineous and broadleaf weeds and cyperaceae weeds. The resistance of corn to topramezone is due to its low sensitivity to target enzymes, less absorption and transportation for topramezone, and faster metabolism. Topramezone can also effectively and stably control broadleaf weeds that have developed resistance to ALS and triazine herbicides.

WO 2008064988 A discloses the preparation of an aqueous composition comprising a monovalent cation salt of topramezone, which can be combined with fertilizers and is compatible and stable. The content of topramezone disclosed therein is 0.005-500 g/L, preferably 10-300 g/L.

WO 2008015280 A discloses a concentrated solution composition of topramezone and dicamba dissolved in water in the form of alkali metal salt or ammonium salt, and the content of topramezone disclosed therein is 10-100 g/L.

WO 2020043470 A1 discloses a topramezone aqueous composition with a content of 0.1-1%, which can be directly sprayed for lawn weeding without dilution.

At present, the commercial products of topramezone are mainly liquid preparations, such as “Stellar Star” from BASF, which is topramezone 50 g/L+dicamba 160 g/L SL; “Armezon”, which is topramezone 336 g/L SC; “Armezon Pro”, which is topramezone 1.12%+dimethenamid-P 56.25% SE.

It has been found that the aqueous spray solution based on the conventional formulation of topramezone or a salt thereof is easy to flocculate, and the filters and nozzles of the spray equipment will be blocked. It is especially easy to flocculate in aqueous spray solution of hard water with a hardness of 300 ppm or more, and even 500 ppm or more. This is not expected by farmers who use mountain spring water or river water with high calcium and magnesium ions to dilute the herbicides.

Those skilled in the art have tried to solve the flocculation of the aqueous spray solution based on topramezone or a salt thereof by adding conventional hard water resistant agents such as sodium tripolyphosphate, sodium pyrophosphate, triethanolamine, sodium alginate, polyhydroxyacrylic acid and maleic acid-acrylic acid copolymer, but still failed to meet expectations.

### SUMMARY

Unexpectedly, it was found that amino carboxylate and/or organic phosphonate can be used to prevent the flocculation of topramezone or a salt thereof in aqueous spray solution based on topramezone or a salt thereof.

One aspect of the invention provides a herbicidal composition, comprising (1) at least one amino carboxylate and/or organic phosphonate, and (2) topramezone or a salt active substance thereof.

Another aspect of the invention provides a herbicidal composition, comprising: (1) at least one amino carboxylate and/or organic phosphonate, (2) topramezone or a salt active substance thereof, (3) at least one diluent, and (4) at least one surfactant.

Yet another aspect of the invention provides an aqueous spray solution, wherein the aqueous spray solution comprises topramezone or a salt active substance thereof, amino carboxylate and/or organic phosphonate and water.

Another aspect of the invention provides a method for inhibiting flocculation of topramezone or a salt active substance thereof by spraying an aqueous spray solution comprising at least one amino carboxylate and/or organic phosphonate and the topramezone or a salt active substance thereof, and the weight ratio of the amino carboxylate and/or organic phosphonate to the topramezone or a salt active substance thereof ranges from 1:100 to 1:1.

Yet another aspect of the invention provides a method for preventing the flocculation of topramezone or a salt active substance thereof, the method comprises adding amino carboxylate and/or organic phosphonate to a herbicidal composition or aqueous spray solution based on the topramezone or a salt active substance thereof, and the weight ratio of the amino carboxylate and/or organic phosphonate to the topramezone or a salt active substance thereof ranges from 1:100 to 1:1.

### BRIEF DESCRIPTION OF THE DRAWING

FIG. 1 is an X-ray powder diffraction pattern recorded at 25° C. and showing a specific X-ray powder diffraction absorption peak for 2.5 water crystal substance of sodium salt of topramezone.

### DETAILED DESCRIPTION OF EXAMPLE EMBODIMENTS

Very surprisingly, by using amino carboxylate and/or organic phosphonate, the flocculation tendency of topramezone or a salt thereof in aqueous spray solution is greatly reduced. The flocculation tendency in an aqueous spray solution using hard water with a hardness of 300 ppm or more and even 500 ppm or more can also be greatly reduced. In addition, the use of amino carboxylate and/or organic phosphonate can prevent the blocking of filters and nozzles in spray equipment during spraying of the aqueous preparations containing topramezone or a salt thereof. It is also advantageous that aminocarboxylate and/or organic phosphonate have no undesired side effects in plant protection.

Suitable amino carboxylates are selected from: aminotriacetate such as trisodium aminotriacetate, ethylenediamine tetraacetate such as disodium ethylenediamine tetraacetate, tetrasodium ethylenediamine tetraacetate, diethylenetriamine pentacarboxylate such as pentasodium diethylenetriamine pentacarboxylate, hydroxyethyl ethylenediamine triacetate such as trisodium hydroxyethyl ethylenediamine triacetate, etc., preferably ethylenediamine tetraacetate.

Suitable organic phosphonates are selected from: ethylenediamine tetramethylene phosphonate such as sodium ethylenediamine tetramethylene phosphonate, diethylenetriamine pentamethylene phosphonate such as sodium diethylenetriamine pentamethylene phosphonate, aminotrimethylene phosphonate such as potassium aminotrimethylene phosphonate, preferably diethylenetriamine pentamethylene phosphonate.

The topramezone or a salt thereof refers to [3-(4,5-dihydro-3-isoxazolyl)-4-methylsulfonyl-2-methylbenzene]5-hydroxy-1-methyl-1H-pyrazole-4-yl)methanone or 3-(4,5-dihydro-3-isoxazolyl)-4-methylsulfonyl-2-methylbenzene]5-hydroxy-1-methyl-1H-pyrazole-4-yl) methanone in the form of salts.

The topramezone salts include for example, sodium salt of topramezone, potassium salt of topramezone, lithium salt of topramezone, ammonium salt of topramezone, topramezone hydrochloride, topramezone sulfate, calcium salt of topramezone, copper salt of topramezone, isopropylammonium salt of topramezone, triethylamine salt of topramezone, etc.

Especially preferred topramezone salts are sodium salt of topramezone, potassium salt of topramezone, lithium salt of topramezone and ammonium salt of topramezone. In some preferred embodiments, sodium salt of topramezone, potassium salt of topramezone, lithium salt of topramezone or ammonium salt of topramezone are preferred.

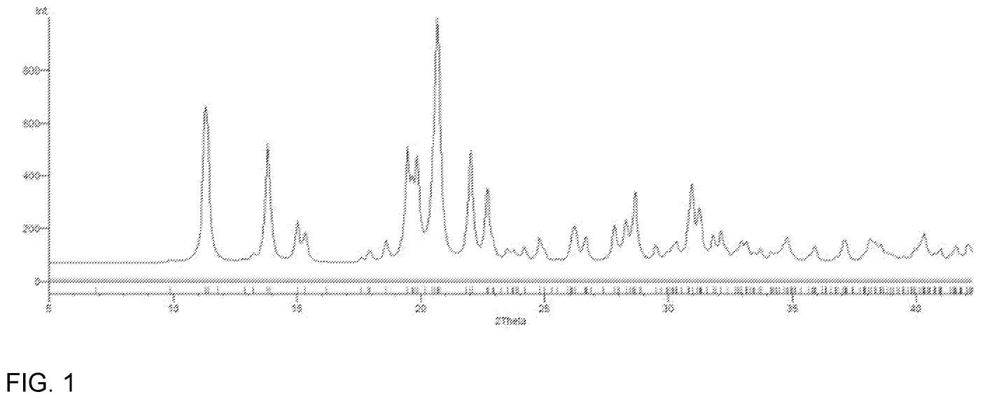

In some particularly preferred embodiments, the water crystal substances of sodium salt of topramezone is particularly preferred. In a specific embodiment, it is selected from the 2.5 water crystal substance of sodium salt of topramezone with a specific X-ray powder diffraction absorption peak, as shown in FIG. 1.

The present invention provides a herbicidal composition, comprising:
(1) at least one amino carboxylate and/or organic phosphonate, and
(2) topramezone or a salt active substance thereof, the weight ratio of the amino carboxylate and/or organic phosphonate to topramezone or a salt active substance thereof is 1: 100-1:1, preferably 1: 50-1:2, particularly preferably 1: 20-1:4.

The present invention further provides a herbicidal composition, comprising: (1) at least one amino carboxylate and/or organic phosphonate,
(2) topramezone or a salt active substance thereof,
(3) at least one diluent, and
(4) at least one surfactant.

In the herbicidal composition of the present invention, the weight ratio of the amino carboxylate and/or organic phosphonate to topramezone or a salt active substance thereof is 1: 100-1:1, preferably 1: 50-1:2, particularly preferably 1: 20-1:4.

In the herbicidal composition of the present invention, the content of topramezone or a salt active substance thereof accounts for 0.1 weight percent (wt. %)-80 wt. %, preferably 1 wt. %-60 wt. %, more particularly preferably 5 wt. %-50 wt. %, and even particularly preferably 15 wt. %-45 wt. %, based on the total weight of the herbicidal composition.

The diluent can be a liquid diluent and a solid diluent. The liquid diluent is usually: aromatic compounds such as Solvesso series, aliphatic hydrocarbons such as cyclohexane, n-hexane, or paraffin, such as petroleum fractions, mineral and vegetable oils, alcohols such as butanol, propanol or ethylene glycol and ethers and esters thereof, ketones such as acetophenone, methyl isobutyl ketone or cyclohexanone, strong polar solvents such as dimethylformamide, N,N-dimethylformamide, propylene carbonate and dimethyl sulfoxide, or water.

The solid diluent is usually, for example, ammonium salts and crushed natural minerals, such as kaolin, clay, talc, chalk, quartz, attapulgite, montmorillonite or silicate; crushed synthetic minerals such as highly dispersed silica, alumina and silicate; natural mineral particles such as kaolin, clay, talc, chalk, quartz, attagel, montmorillonite or diatomite; synthetic mineral particles, such as highly dispersed silicic acid, alumina and silicate; crushed and graded natural rocks such as calcite, marble, pumice, sepiolite and dolomite; inorganic synthetic particles and organic powders; organic product particles, such as saw timber, coconut shell, corn cob and tobacco stem; inorganic salts, such as ammonium sulfate and potassium sulfate; and organics, such as sucrose, starch, lactose, urea, cellulose, polyvinyl alcohol, and methyl pyrrolidone.

In the herbicidal composition of the present invention, the content of liquid and/or solid diluent accounts for 1 wt. %-99 wt. %, preferably 5 wt. %-90 wt. %, particularly preferably 10 wt. %-80 wt. %, more particularly preferably 15 wt. %-70 wt. %, and even particularly preferably 20 wt. %-60 wt. %, based on the total weight of the herbicidal composition.

The surfactant itself has no biological activity, but can improve the dispersion, wetting and emulsifying effects of the active substances in the preparation system and properties such as spreading, wetting, penetration, and adhesion of the active ingredients on the surface of plants. Surfactants include anionic, nonionic, cationic and amphoteric surfactants, block polymers, polyelectrolytes, and mixtures thereof. Such surfactants can be used as emulsifiers, dispersants, cosolvents, wetting agents, penetrants, protective colloids or adjuvants.

Suitable anionic surfactants are alkali metals, alkaline earth metals or ammonium salts of sulfonic acid, sulfuric acid, phosphoric acid, and carboxylic acid, and mixtures thereof. Examples of sulfonates are alkyl aryl sulphonates, diphenyl sulfonates, α-olefin sulfonates, lignin sulfonates, sulfonates of fatty acids and oils, sulfonates of ethoxylated alkylphenols, sulfonates of alkoxylated arylphenols, sulfonates of condensed napthalenes, sulfonates of dodecyl- and tridecylbenzenes, sulfonates of naphthalenes and alkylnaphthalenes, sulfosuccinates or sulphosuccinamates. Examples of sulfates are sulfates of fatty acids and oils, sulfates of ethoxylated alkylphenols, sulfates of alcohols, sulfates of ethoxylated alcohols or sulfates of fatty acid esters. Examples of phosphates are phosphate esters. Examples of carboxylates are alkyl carboxylates and carboxylated alcohol or alkylphenol ethoxylates. Preferred anionic surfactants are sulfates and sulfonates.

Suitable nonionic surfactants are alkoxylates, N-substituted fatty acid amides, amine oxides, esters, glycosyl surfactants, polymeric surfactants and mixtures thereof. Examples of alkoxylates are compounds such as alcohols, alkylphenols, amines, amides, arylphenols, fatty acids or fatty acid esters alkoxylated with 1-50 equivalents. Ethylene oxide and/or propylene oxide can be used for alkoxylation, preferably ethylene oxide. Examples of N-substituted fatty acid amides are fatty acid glucamides or fatty acid alkanolamides. Examples of esters are fatty acid esters, glycerides or monoglycerides. Examples of glycosyl surfactants are sorbitan, ethoxylated sorbitan, sucrose and glucose esters, or alkyl polyglucosides. Examples of polymeric surfactants are homopolymers or copolymers of vinylpyrrolidone, vinyl alcohol or vinyl acetate. Preferred nonionic surfactants are alkoxylates. Nonionic surfactants such as alkoxylates can also be used as adjuvants.

Suitable cationic surfactants are quaternary-type surfactants, such as quaternary ammonium compounds having 1 or 2 hydrophobic groups, or salts of long-chain primary amines.

Suitable amphoteric surfactants are alkyl betaines and imidazolines.

Suitable block polymers are A-B or A-B-A type block polymers comprising blocks of polyoxyethylene and polyoxypropylene, or A-B-C type block polymers comprising alkanol, polyoxyethylene and polyoxypropylene.

Preferably, the polyelectrolytes are copolymers comprising, in the polymerized form, amides containing at least one monomer selected from N-vinyllactam, N—C₁-C₆ alkyl acrylamide and N,N-di C₁-C₆ alkyl acrylamide; poly(C₂₋₆ alkylene glycol) (meth)acrylate and/or mono C1-22 alkyl-terminated poly(C₂₋₆ alkylene glycol) (meth)acrylate; C₁-C₈ alkyl (meth)acrylate. More preferably, the polyelectrolytes are copolymers comprising, in the polymerized form, amides containing at least one monomer selected from N-vinyllactam; mono C₁₋₂₂ alkyl-terminated poly(C₂₋₆ alkylene glycol) (meth)acrylate; C₁-C₈ alkyl (meth)acrylate; and (meth)acrylic acid.

In the herbicidal composition of the present invention, the content of surfactant accounts for 0.1 wt. %-30 wt. %, preferably 0.5 wt. %-25 wt. %, particularly preferably 1 wt. %-20 wt. %, more particularly preferably 2 wt. %-15 wt. %, and even particularly preferably 3 wt. %-10 wt. % of the composition.

The present invention can also comprise suitable adjuvants, the adjuvants are compounds that have negligible pesticide activity or even have no pesticide activity itself and don't improve the biological performance of the pesticide on a target object. For example, it can be a defoamer, an antifreeze agent, a thickener, a preservative, an antioxidant, and a colorant, etc.

Suitable defoamers include all substances commonly used for such purposes in agrochemical compositions, preferably, the defoamer is a silicone defoamer, and preferably siloxane defoamer.

Suitable antifreeze agents include all substances commonly used for such purposes in agrochemical compositions, preferably, the antifreeze agent is propylene glycol and/or ethylene glycol.

Suitable thickeners include all substances commonly used for such purposes in agrochemical compositions, preferably, the thickener is xanthan gum.

Suitable preservatives include all substances commonly used for such purposes in agrochemical compositions, preferably, the preservative is selected from Proxel series and/or Nipacide series preservatives.

Suitable antioxidants include all substances commonly used for such purposes in agrochemical compositions, preferably, the antioxidant is 2,6-di-tert-butyl-4-methylphenol.

Suitable colorants include all substances commonly used for such purposes in agrochemical compositions, preferably, the colorant is any one or a combination of at least two of titanium dioxide, zinc oxide, blue pigment or Pigment Red BBN (i.e. everbright fast red BBN).

In the present invention, there can also be other herbicides that do not have antagonistic effect with topramezone or a salt thereof.

Suitable herbicides are, for example, acetamide herbicides: acetochlor, alachlor, butachlor, dimethachlor, dimethenamid, flufenacet, mefenacet, metolachlor, metazachlor, napropamide, naproanilide, pethoxamid, pretilachlor, propachlor, and thenylchlor; amino acid derivative herbicides: glyphosate, glufosinate, and sulfosate; aryloxyphenoxypropionate herbicides: clodinafop, cyhalofop-butyl, fenoxaprop, fluazifop, haloxyfop, metamifop, propaquizafop, quizalofop, and quizalofop-P-tefuryl; cyclohexanedione herbicides: butroxydim, clethodim, cycloxydim, profoxydim, sethoxydim, tepraloxydim, and tralkoxydim; dinitroaniline herbicides: benfluralin, ethalfluralin, pendimethalin, prodiamine, and trifluralin; diphenyl ether herbicides: acifluorfen, aclonifen, bifenox, diclofop, ethoxyfen, fomesafen, lactofen, and oyfluorfen; triazine herbicides: ametryn, atrazine, cyanazine, dimethametryn, ethiozin, hexazinone, metamitron, metribuzin, prometryn, simazine, terbuthylazine, terbutryn, and triaziflam; pyridine herbicides: aminopyralid, clopyralid, diflufenican, dithiopyr, fluridone, fluroxypyr, picloram, picolinafen, and thiazopyr; sulfonylurea herbicides: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, and tritosulfuron; urea herbicides: chlorotoluron, daimuron, diuron, fluometuron, isoproturon, linuron, methabenzthiazuron, and tebuthiuron; amicarbazone, aminotriazole, anilofos, beflubutamid, benazolin, benzofenap, bentazone, benzobicyclon, bicyclopyrone, bromacil, bromobutide, butafenacil, butamifos, cafenstrole, carfentrazone, cinidon-ethyl, chlorthal, cinmethylin, clomazone, cumyluron, cyprosulfamide, dicamba, difenzoquat, diflufenzopyr, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methylarsonicacid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, etc.

Topramezone or a salt active substance thereof can be used in conventional preparations. The stable herbicidal composition of the present invention can be prepared into conventional solid or liquid preparations. The herbicidal composition is preferably applied in the form of an aqueous spray solution.

When the herbicidal composition of the present invention is applied in the form of an aqueous spray solution, the flocculation tendency of topramezone or a salt thereof in the aqueous spray solution is greatly reduced, especially the flocculation tendency in the aqueous spray solution with a hardness of 300 ppm or more, and even 500 ppm or more is also greatly reduced.

It is also found that the amino carboxylate and/or organic phosphonate of the present invention can be used to prevent the flocculation of topramezone or a salt active substance thereof in aqueous spray solution when the aqueous spray solution containing topramezone or a salt active substance thereof is applied, especially the flocculation in the aqueous spray solution with a hardness of 300 ppm or more, and even 500 ppm or more.

Use of the amino carboxylate and/or organic phosphonate in inhibiting the flocculation of topramezone or a salt active substance thereof when spraying the aqueous spray solution comprising at least one amino carboxylate and/or organic phosphonate and topramezone or a salt active substance thereof, and the weight ratio of the amino carboxylate and/or organic phosphonate to topramezone or a salt active substance thereof is 1: 100-1:1, preferably 1: 50-1:2, particularly preferably 1: 20-1:4.

The aqueous spray solution of the present invention comprises topramezone or a salt active substance thereof, amino carboxylate and/or organic phosphonate and water.

In the spray solution of the present invention, the concentration of topramezone or a salt active substance thereof can vary within a certain range. Generally, the concentration of topramezone or a salt active substance thereof is 0.0001 wt. % to 1 wt. %, preferably 0.001 wt. % to 0.5 wt. %, based on the total weight of the solution. The concentration of aminocarboxylate and/or organic phosphonate is 0.00001 wt. % to 0.5 wt. % preferably 0.0005 wt. % to 0.1 wt. %, based on the total weight of the solution.

The weight ratio of the amino carboxylate and/or organic phosphonate to topramezone or a salt active substance thereof in the aqueous spray solution is 1: 100-1:1, especially 1: 50-1:2, particularly especially 1: 20-1:4.

Further, the present invention provides a new use of amino carboxylate and/or organic phosphonate, especially the amino carboxylate and/or organic phosphonate can be used to prevent the flocculation of topramezone or a salt active substance thereof in aqueous spray solution when the aqueous spray solution containing topramezone or a salt active substance thereof is applied, especially the flocculation in the aqueous spray solution with a hardness of 300 ppm or more, and even 500 ppm or more.

The aqueous spray solution which can be used in the present invention is prepared by a common method. Generally, the process comprises firstly mixing the required components in any desired order between 10° C. and 30° C., so as to mix the batch of materials until uniform. And, if necessary, the resulting mixture is filtered to prepare a concentrate. In order to prepare the aqueous spray solution ready for use, the concentrated preparations are mixed with the water in a required amount under various conditions (if necessary, under mixing and/or suction) to uniformly disperse the preparations in water.

All mixing equipment and spray devices generally suitable for these purposes can be used for the preparation of concentrated preparations and for the preparation and application of the aqueous spray solution that can be used in the present invention.

By using the amino carboxylate and/or organic phosphonate in the aqueous spray solution based on topramezone and/or a salt active substance thereof, the flocculation of the active compounds is completely prevented, or prevented to a degree that the application of the aqueous spray solution is not adversely affected when concentrated, commercial preparation and aqueous spray liquid prepared with this preparation are applied to the filter and outlet of the sprayer.

Still further, the present invention provides a method for preventing the flocculation of topramezone or a salt active substance thereof in aqueous spray solution, the method comprises adding an appropriate amount of amino carboxylate and/or organic phosphonate to the herbicidal composition or aqueous spray solution based on topramezone or a salt active substance thereof to reduce the flocculation of topramezone or a salt active substance thereof in aqueous spray solution.

### Examples

The present invention will be further described below in conjunction with examples:

| Example 1 | | |
|---|---|---|
| Sodium salt of topramezone | 20 | wt. % SL |
| Sodium salt of topramezone | 20 | wt. % |
| Fatty alcohol ethoxylate | 2 | wt. % |
| Tetrasodium ethylenediamine tetraacetate | 5 | wt. % |
| Deionized water | making up to 100 wt. % | |
| Example 2 | | |
| Potassium salt of topramezone | 40 | wt. % SG |
| Potassium salt of topramezone | 40 | wt. % |
| Sodium diethylenetriamine pentamethylene phosphonate | 5 | wt. % |
| Naphthalenesulfonate formaldehyde condensate | 4 | wt. % |
| Sodium dodecyl benzenesulfonate | 2 | wt. % |
| Polyvinyl alcohol | 1 | wt. % |
| Sucrose | making up to 100 wt. % | |
| Example 3 | | |
| Sodium salt of topramezone | 50 | wt. % SG |
| Sodium salt of topramezone | 50 | wt. % |
| Sodium ethylenediamine tetramethylene phosphonate | 6 | wt. % |
| Lignosulphonate | 3 | wt. % |
| Solid defoamer | 0.5 | wt. % |
| White carbon black | 3 | wt. % |
| Lactose monohydrate | making up to 100 wt. % | |
| Example 4 | | |
| Ammonium salt of topramezone | 15 | wt. % SL |
| Ammonium salt of topramezone | 15 | wt. % |
| Polysiloxane | 0.2 | wt. % |
| Sodium diethylenetriamine pentacarboxylate | 4 | wt. % |
| Deionized water | making up to 100 wt. % | |
| Example 5 | | |
| Sodium salt of topramezone 10 wt. % + | | |
| Sodium salt of dicamba 10 wt. % SL | | |
| Sodium salt of topramezone | 10 | wt. % |
| Sodium salt of dicamba | 10 | wt. % |
| Potassium aminotrimethylene phosphonate | 5 | wt. % |
| Sodium hydroxide | 2 | wt. % |
| Deionized water | making up to 100 wt. % | |
| Example 6 | | |
| 2.5 water crystal substance of sodium salt | 25 | wt. % SG |
| of topramezone | | |
| 2.5 water crystal substance of sodium salt of topramezone | 25 | wt. % |
| Sodium ethylenediamine tetraacetate | 3 | wt. % |
| Naphthalenesulfonate formaldehyde condensate | 3 | wt. % |
| Dioctylsuccinate sulfonate | 3 | wt. % |
| Polyvinylpyrrolidone | 1 | wt. % |
| Potassium sulphate % | making up to 100 wt. % | |
| Comparative Example 1 | | |
| Sodium salt of topramezone | 20 | wt. % SL |
| Sodium salt of topramezone | 20 | wt. % |
| Fatty alcohol ethoxylate | 2 | wt. % |
| Deionized water | making up to 100 wt. % | |
| Comparative Example 2 | | |
| Sodium salt of topramezone | 20 | wt. % SL |
| Sodium salt of topramezone | 20 | wt. % |
| Fatty alcohol ethoxylate | 2 | wt. % |
| Sodium tripolyphosphate | 5 | wt. % |
| Deionized water | making up to 100 wt. % | |
| Comparative Example 3 | | |
| Potassium salt of topramezone | 40 | wt. % SG |
| Potassium salt of topramezone | 40 | wt. % |
| Naphthalenesulfonate formaldehyde condensate | 4 | wt. % |
| Sodium dodecyl benzenesulfonate | 2 | wt. % |
| Sodium carbonate | 1 | wt. % |
| Sucrose | making up to 100 wt. % | |
| Comparative Example 4 | | |
| Potassium salt of topramezone | 40 | wt. % SG |
| Potassium salt of topramezone | 40 | wt. % |
| Polyhydroxyacrylic acid | 5 | wt. % |
| Naphthalenesulfonate formaldehyde condensate | 4 | wt. % |
| Sodium dodecyl benzenesulfonate | 2 | wt. % |
| Sodium carbonate | 1 | wt. % |
| Sucrose | making up to 100 wt. % | |
| Comparative Example 5 | | |
| Sodium salt of topramezone | 50 | wt. % SG |
| Sodium salt of topramezone | 50 | wt. % |
| Lignosulphonate | 3 | wt. % |
| Solid defoamer | 0.5 | wt. % |
| White carbon black | 3 | wt. % |
| Lactose monohydrate | making up to 100 wt. % | |
| Comparative Example 6 | | |
| Sodium salt of topramezone | 50 | wt. % SG |
| Sodium salt of topramezone | 50 | wt. % |
| Sodium pyrophosphate | 6 | wt. % |
| Lignosulphonate | 3 | wt. % |
| Solid defoamer | 0.5 | wt. % |
| White carbon black | 3 | wt. % |
| Lactose monohydrate | making up to 100 wt. % | |
| Comparative Example 7 | | |
| Ammonium salt of topramezone | 15 | wt. % SL |
| Ammonium salt of topramezone | 15 | wt. % |
| Polysiloxane | 0.2 | wt. % |
| Deionized water | making up to 100 wt. % | |
| Comparative Example 8 | | |
| Ammonium salt of topramezone | 15 | wt. % SL |
| Ammonium salt of topramezone | 15 | wt. % |
| Polysiloxane | 0.2 | wt. % |
| Triethanolamine | 4 | wt. % |
| Deionized water | making up to 100 wt. % | |
| Comparative Example 9 | | |
| Sodium salt of topramezone 10 wt. % + | | |
| Sodium salt of dicamba 10 wt. % SL | | |
| Sodium salt of topramezone | 10 | wt. % |
| Sodium salt of dicamba | 10 | wt. % |
| Sodium hydroxide | 2 | wt. % |
| Deionized water | making up to 100 wt. % | |
| Comparative Example 10 | | |
| Sodium salt of topramezone 10 wt. % + | | |
| Sodium salt of dicamba 10 wt. % SL | | |
| Sodium salt of topramezone | 10 | wt. % |
| Sodium salt of dicamba | 10 | wt. % |
| Maleic acid acrylic copolymer | 5 | wt. % |
| Sodium hydroxide | 2 | wt. % |
| Deionized water | making up to 100 wt. % | |
| Comparative Example 11 | | |
| 2.5 water crystal substance of sodium | 25 | wt. % SG |
| salt of topramezone | | |
| 2.5 water crystal substance of sodium | 25 | wt. % |
| salt of topramezone | | |
| Naphthalenesulfonate formaldehyde condensate | 3 | wt. % |
| Dioctylsuccinate sulfonate | 3 | wt. % |
| Polyvinylpyrrolidone | 1 | wt. % |
| Potassium sulphate | making up to 100 wt. % | |
| Comparative Example 12 | | |
| 2.5 water crystal substance of sodium | 25 | wt. % SG |
| salt of topramezone | | |
| 2.5 water crystal substance of sodium | 25 | wt. % |
| salt of topramezone | | |
| Sodium tripolyphosphate | 3 | wt. % |
| Naphthalenesulfonate formaldehyde condensate | 3 | wt. % |
| Dioctylsuccinate sulfonate | 3 | wt. % |
| Polyvinylpyrrolidone | 1 | wt. % |

| | |
|---|---|
| Potassium sulphate | making up to 100 wt. % |

### Application Example

In order to test the anti-flocculation effect, the samples of the above Examples 1-6 and Comparative Examples 1-12 are diluted 500 times with soft water (hardness: 100 ppm), medium hard water (hardness: 250 ppm), hard water (hardness: 350 ppm) and high hard water (hardness: 500 ppm). After stirring evenly, it is left to stand at normal temperature for 30 minutes and observed. Experiment results can be seen in Table 1.

TABLE 1

| | Soft | Medium | Hard | High |
|---|---|---|---|---|
| | water | hard water | water | hard water |
| Example 1 | − | − | − | − |
| Example 2 | − | − | − | + |
| Example 3 | − | − | − | + |
| Example 4 | − | − | − | + |
| Example 5 | − | − | − | + |
| Example 6 | − | − | − | − |
| Comparative | − | ++ | +++ | +++ |
| Example 1 | | | | |
| Comparative | − | + | ++ | +++ |
| Example 2 | | | | |
| Comparative | − | ++ | +++ | +++ |
| Example 3 | | | | |
| Comparative | − | + | ++ | +++ |
| Example 4 | | | | |
| Comparative | − | ++ | +++ | +++ |
| Example 5 | | | | |
| Comparative | − | + | ++ | +++ |
| Example 6 | | | | |
| Comparative | − | ++ | +++ | +++ |
| Example 7 | | | | |
| Comparative | − | + | ++ | +++ |
| Example 8 | | | | |
| Comparative | − | ++ | +++ | +++ |
| Example 9 | | | | |
| Comparative | − | + | ++ | +++ |
| Example 10 | | | | |
| Comparative | − | ++ | +++ | +++ |
| Example 11 | | | | |
| Comparative | − | + | ++ | +++ |
| Example 12 | | | | |

Notes:
“−” indicates no or almost no flocculation;
“+” indicates a small or very small amount of flocculation;
“++” indicates that there is or a large amount of flocculation;
“+++” indicates a large amount of flocculation or flocculate sedimentation.

In the herbicidal composition based on topramezone or a salt active substance thereof of the present invention, amino carboxylate (sodium ethylenediamine tetraacetate, diethylenetriamine pentacarboxylate) and organic phosphonate (ethylenediamine tetramethylene phosphonate, sodium diethylenetriamine pentamethylene phosphonate, and potassium aminotrimethylene phosphonate) effectively inhibit the flocculation of topramezone or a salt active substance thereof in aqueous spray solution, especially the flocculation in the aqueous spray solution with a hardness of 300 ppm or more and even 500 ppm or more, whereas the samples of Comparative Examples 1, 3, 5, 7, 9, and 11 without adding the amino carboxylate and organic phosphonate of the present invention have more flocculation in the water with a 250 ppm of medium hardness, while there are a lot of flocculation and floc sedimentation in 350 ppm and 500 ppm of hard water. The flocculation in 250 ppm of medium hard water and 350 ppm of hard water can be improved in the Comparative Examples 2, 4, 6, 8, 10 and 12 with addition of conventional hard water resistant agents correspondingly, but there is still a small amount or more flocculation, while in 500 ppm of high hard water, there is a large amount of flocculation and flocculate sedimentation.

What is claimed is:

1. A herbicidal composition, comprising:
(1) at least one amino carboxylate and/or organic phosphonate,
and
(2) topramezone or a salt active substance thereof.

2. The herbicidal composition according to claim 1, wherein the weight ratio of the at least one amino carboxylate and/or organic phosphonate to the topramezone or a salt active substance thereof ranges from 1:100 to 1:1.

3. The herbicidal composition according to claim 1, wherein the content of the topramezone or a salt active substance thereof accounts for 0.1 wt. %-80 wt. %, of the total weight of the herbicidal composition.

4. The herbicidal composition according to claim 1, wherein the topramezone or a salt active substance thereof is selected from topramezone, lithium salt of topramezone, topramezone potassium salt, sodium salt of topramezone and ammonium salt of topramezone.

5. The herbicidal composition according to claim 4, wherein the topramezone or a salt active substance thereof is selected from the sodium salt of topramezone and the potassium salt of topramezone.

6. The herbicidal composition according to claim 4, wherein the topramezone or a salt active substance thereof includes the sodium salt of topramezone.

7. The herbicidal composition according to claim 1, wherein the amino carboxylate is selected from aminotriacetate, ethylenediamine tetraacetate and diethylenetriamine pentacarboxylate.

8. The herbicidal composition according to claim 1, wherein the amino carboxylate is selected from trisodium aminotriacetate, disodium ethylenediamine tetraacetate, tetrasodium ethylenediamine tetraacetate, pentasodium diethylenetriamine pentacarboxylate, trisodium hydroxyethyl ethylenediamine triacetate and ethylenediamine tetraacetate.

9. The herbicidal composition according to claim 1, wherein the organic phosphonate is selected from ethylenediamine tetramethylene phosphonate, diethylenetriamine pentamethylene phosphonate and aminotrimethylene phosphonate.

10. The herbicidal composition according to claim 1, wherein the organic phosphonate is selected from sodium ethylenediamine tetramethylene phosphonate, sodium diethylenetriamine pentamethylene phosphonate and potassium aminotrimethylene phosphonate.

11. A herbicidal composition, comprising:
(1) at least one amino carboxylate and/or organic phosphonate,
(2) topramezone or a salt active substance thereof,
(3) at least one diluent, and
(4) at least one surfactant.

12. The herbicidal composition according to claim 11, wherein the surfactant is selected from one of a dispersant, a wetting agent, a synergist, a defoamer and an antifreeze agent or a mixture thereof.

13. The herbicidal composition according to claim 11, wherein the diluent is selected from a solid diluent and a liquid diluent.

14. The herbicidal composition according to claim 11, wherein the liquid diluent is water.

15. The herbicidal composition according to claim 11, wherein the herbicidal composition further comprises other herbicidal active substances.

16. An aqueous spray solution, comprising the herbicidal composition according to claim 1 and water.

17. An aqueous spray solution, wherein the aqueous spray solution comprises topramezone or a salt active substance thereof, amino carboxylate and/or organic phosphonate and water.

18. The aqueous spray solution according to claim 17, wherein the weight ratio of the amino carboxylate and/or organic phosphonate to the topramezone or a salt active substance thereof ranges from 1:100 to 1:1.

19. The aqueous spray solution according to claim 17, wherein the content of the topramezone or a salt active substance thereof ranges from 0.0001 wt. % to 1 wt. %, of the total weight of the solution.

20. A method for inhibiting flocculation of topramezone or a salt active substance thereof by spraying an aqueous spray solution comprising at least one amino carboxylate and/or organic phosphonate and the topramezone or a salt active substance thereof, and the weight ratio of the amino carboxylate and/or organic phosphonate to the topramezone or a salt active substance thereof ranges from 1:100 to 1:1.

21. A method for preventing the flocculation of topramezone or a salt active substance thereof, the method comprises adding amino carboxylate and/or organic phosphonate to a herbicidal composition or aqueous spray solution based on the topramezone or a salt active substance thereof, and the weight ratio of the amino carboxylate and/or organic phosphonate to the topramezone or a salt active substance thereof ranges from 1:100 to 1:1.

22. The herbicidal composition according to claim 1, wherein the weight ratio of the at least one amino carboxylate and/or organic phosphonate to the topramezone or a salt active substance thereof ranges from 1:50 to 1:2.

23. The herbicidal composition according to claim 1, wherein the content of the topramezone or a salt active substance thereof ranges from 1 wt. %-60 wt. % of the total weight of the herbicidal composition.

24. The aqueous spray solution according to claim 17, wherein the content of the topramezone or a salt active substance thereof ranges from 0.0001 wt. % to 1 wt. % of the total weight of the herbicidal composition.
